(19) United States
(12) Patent Application Publication
(10) Pub. No.: US 2007/0144364 A1
(43) Pub. Date: Jun. 28, 2007

(54) INKJET PAD PRINTER

(76) Inventor: ROBERT HITCHCOCK, West Chicago, IL (US)

Correspondence Address: CARDINAL LAW GROUP, Suite 2000, 1603 Orrington Avenue, Evanston, IL, 60201, US

(21) Appl. No.: 11/616,640

(22) Filed: Dec. 27, 2006

Related U.S. Application Data
(60) Provisional application No. 60/754,403, filed on Dec. 28, 2005.

(51) Int. Cl. B41F 17/00

(52) U.S. Cl. 101/41

(57) ABSTRACT

A pad printing system has an ink jet printing mechanism, a cliché device including an imaging surface, a pad assembly including a deformable pad, and an ink jet printing controller. The ink jet printing controller controls positioning of the ink jet printing mechanism to deposit a ink jet deposited image on the imaging surface. A method of printing an image on a workpiece surface includes forming an ink jet deposited image on an imaging surface of a cliché device, transferring the ink jet deposited image from the imaging surface to a deformable pad, and transferring the ink jet deposited image from the deformable pad to the workpiece surface.

### RELATED APPLICATIONS

This application claims the benefit of U.S. Provisional Patent Application 60/754,403 filed Dec. 28, 2005, the entirety of which is incorporated by reference herein.

### BACKGROUND OF THE INVENTION

The present invention relates to pad printers. More particularly, the present invention relates to a pad printing system.

Pad printing systems are used to apply print, e.g. trademarks and decorations, on non-flat surfaces. For example, pad printing systems can be used to print logos and the like on game balls such as golf balls. Such printing must be carried out on a surface that is not only spherical but is often dimpled as well.

A conventional pad printing system uses a flat cliché plate which has an etching or engraving of a printable image formed thereon. The system transfers ink from an ink supply to the plate, where the ink fills into the etched areas. The system presses a deformable pad onto the cliché plate, and the deformable pad picks up the ink. The system then presses the deformable pad against the surface to be printed, transferring the image to the surface.

The design of the cliché plate determines the printed image. Printing a new image requires the fabrication of a new cliché plate, with attendant expense and delay. Changing the image to be printed requires that one cliché plate be removed from the system and another be installed, which may require halting an entire production line.

Another disadvantage of a conventional pad printing system is that because the system applies ink to the entire cliché plate, the system can print only one color or type of ink at a time. Printing a multicolor image requires several separate printing operations, one for each color. This increases the number of steps required to produce a product, increasing the time and cost of production. The separate printing steps also make color registration more difficult to achieve.

It is desirable to advance the art.

### SUMMARY OF THE INVENTION

One aspect of the invention provides a pad printing system comprising an ink jet printing mechanism, a cliché device including at least one imaging surface, at least one pad assembly including a deformable pad, the pad assembly operably engagable with the cliché device, and an ink jet printing controller operably attached to the ink jet printing mechanism, wherein the ink jet printing controller controls positioning and ink flow of the ink jet printing mechanism to form a ink jet deposited image on the imaging surface.

A second aspect of the invention provides a system for printing an image on a workpiece surface, the system comprising means for operating an ink jet printing mechanism to form an image on a cliché device by depositing ink in a ink jet deposited image, means for transferring the image from the cliché device to a deformable pad, and means for transferring the image from the deformable pad to the workpiece surface.

A third aspect of the invention provides a method of printing an image on a workpiece surface, comprising forming an image on an imaging surface of a cliché device by depositing ink with an ink jet printing mechanism, transferring the image from the imaging surface to a deformable pad, and transferring the image from the deformable pad to the workpiece surface. The foregoing embodiments and other embodiments, objects, and aspects as well as features and advantages of the present invention will become further apparent from the following detailed description of various embodiments of the present invention. The detailed description and drawings are merely illustrative of the present invention, rather than limiting the scope of the present invention being defined by the appended claims and equivalents thereof.

### BRIEF DESCRIPTION OF THE DRAWINGS

FIG. 1 is a schematic representation in accordance with one embodiment of the invention.

FIG. 2 is a schematic representation in accordance with another embodiment of the invention.

FIG. 3 is a schematic representation in accordance with another embodiment of the invention.

FIG. 4 is a flowchart representation of a method of printing an image on a workpiece surface with an ink jet pad printing system according to the invention.

### DETAILED DESCRIPTION OF THE INVENTION

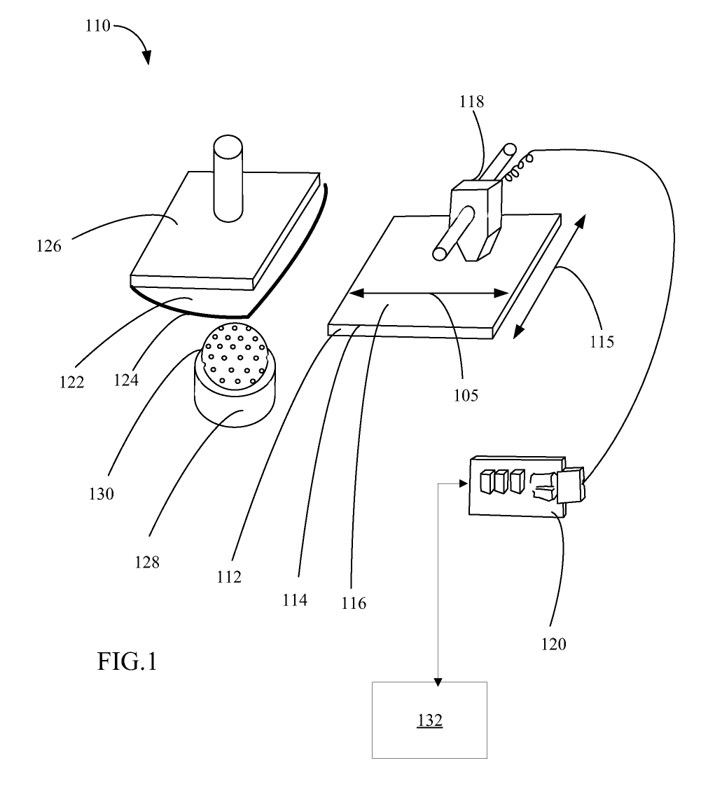

Referring to FIG. 1, one embodiment of an ink jet pad printing system in accordance with the invention is generally shown at 11 0.

The ink jet pad printing system includes a cliché device 112. The ink jet pad printing system forms an image by depositing ink on an imaging surface 114, which is located on an exposed surface of the cliché device 112. An image formed by the ink jet printing system depositing ink on the imaging surface 114 will herein be called an “ink jet deposited image.

The imaging surface 114 includes at least one etched zone 116 that is configured to hold deposited ink in such manner that ink will remain in position where deposited, and will not run or spread. In one embodiment of the invention the etched zone 116 is created by etching the entire imaging surface 114 to a depth of between 5 microns and 100 microns. In one embodiment, the etched zone 116 includes uniform etching that is not indicative of the ink jet deposited image.

An ink jet printing mechanism 118 is in proximity to the imaging surface 114, and is positionable in both a first direction and a second direction, enabling the ink jet printing mechanism 118 to deposit ink over at least a portion of the etched zone 1 16. An ink jet printing controller 120 is operably attached to the ink jet printing mechanism 118. Ink jet printing mechanism is positionable with reference to the etched zone 116 along a first direction 105 or a second direction 115.

A deformable pad 122 with an exposed pad surface 124 is so configured that when the deformable pad 122 is pressed against the cliché device 112 the ink jet deposited image on the imaging surface 114 is substantially completely transferred to the pad surface 124. A deformable pad is defined as a structure configured to assume the shape of an object that is pressed against the deformable pad, either by pressing the object against the deformable pad, or by pressing the deformable pad against the object. As used herein, “substantially completely transferred” means that any ink not transferred is insufficient to produce a ghost image in a subsequent printing cycle of the ink jet pad printing system. A ghost image is any deposition of ink at a location not in accordance with the ink jet deposited image.

A pad assembly 126 holds and moves the deformable pad 122. A workpiece holder 128 holds a workpiece 130 in position for a printing operation. In one embodiment, workpiece holder 128 is configured to transport the workpiece 130 into position before the printing operation and away after the printing operation.

In operation, the ink jet printing controller 120 moves the ink jet printing mechanism 118 over the imaging surface 114 and controls a flow of ink to form an ink jet deposited image on the imaging surface 114. The ink jet printing mechanism 118 then moves away from the cliché device 112. The pad assembly 126 moves over the cliché device 112 and presses the deformable pad 122 against the imaging surface 114, flattening the pad surface 124 of the deformable pad 122 against the imaging surface 114 and transferring the ink jet deposited image from the imaging surface 114 to the pad surface 124 of the deformable pad 122. The pad assembly 126 then lifts the deformable pad 122 away from the cliché device 112. Based on transferring the ink jet deposited image from the cliché device 112 to the deformable pad 122, the deformable pad 122 is positioned near a workpiece 130, and presses the deformable pad 122 against the workpiece 130, transferring the ink jet deposited image from the pad surface 124 to the workpiece 130.

The ink jet printing controller 120 can now reposition the ink jet printing mechanism 118 over the cliché device 112 and begin forming another ink jet deposited image.

The ink jet printing controller 120 can be operably attached to a computer 132. The computer 132 can direct the ink jet printing controller 120 to form a different ink jet deposited image on the imaging surface 114 in each printing operation. Thus the ink jet pad printing system 110 can print a unique image on each workpiece 130, containing a unique serial number or the like. Computer 132 can be any general purpose computing device, or can be an ASIC controller. Additionally, in one embodiment, computer 132 is connected to a network, such as a WAN, LAN, or the Internet, to enable remote control of the pad printing processes described herein.

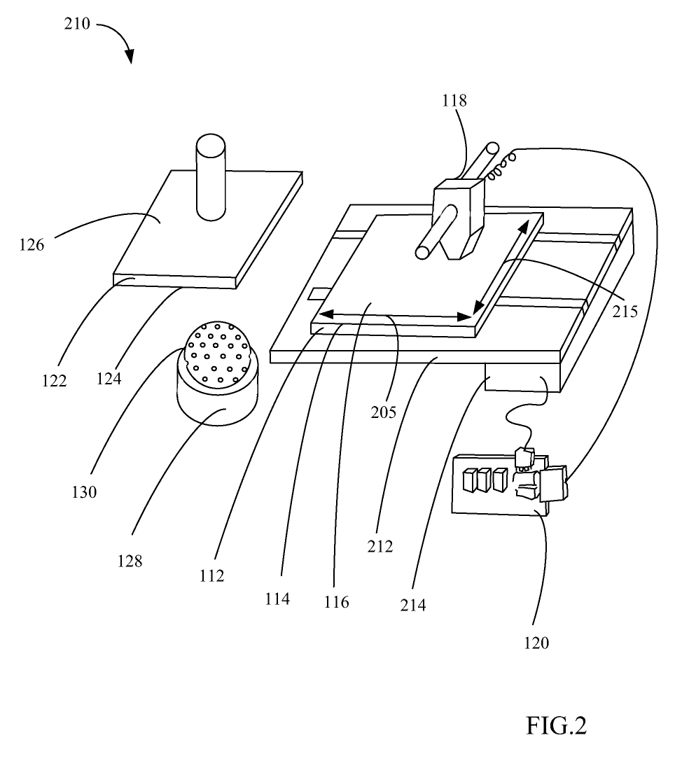

Referring to FIG. 2, another embodiment of an ink jet pad printing system in accordance with the invention is generally shown at 210. In FIG. 2, like reference numbers indicate like structures. In FIG. 2, ink jet printing mechanism is positionable only in first direction 215, while the cliché plate device 112 is positionable along cliché device transport bed 212 in second direction 205

The embodiment shown in FIG. 2 further includes a cliché device transport bed 212. The cliché device 112 is mounted on the cliché device transport bed 212 in such manner that the cliché device 112 can move in the second direction 205. A cliché device transport mechanism 214 is operably attached to the cliché device transport bed 212, to the cliché device 112, and to the ink jet printing controller 120 in such manner that the cliché device transport mechanism 214 can move the cliché device 112 in the second direction 205 under control of the ink jet printing controller 120.

In operation, the ink jet printing controller 120 controls the ink flow of the ink jet printing mechanism 118, the position in the first direction 215 of the ink jet printing mechanism 118, and the position in the second direction 205 of the cliché device 112, thereby forming an ink jet deposited image on the imaging surface 114.

After the ink jet printing mechanism 118 has formed an ink jet deposited image on the imaging surface 114, the ink jet printing controller 120 clears the space above the imaging surface 114 by moving the ink jet printing mechanism 118 away from the cliché device 112 in the first direction 215 or by moving the cliché device 112 away from the ink jet printing mechanism 118 in the second direction 205.

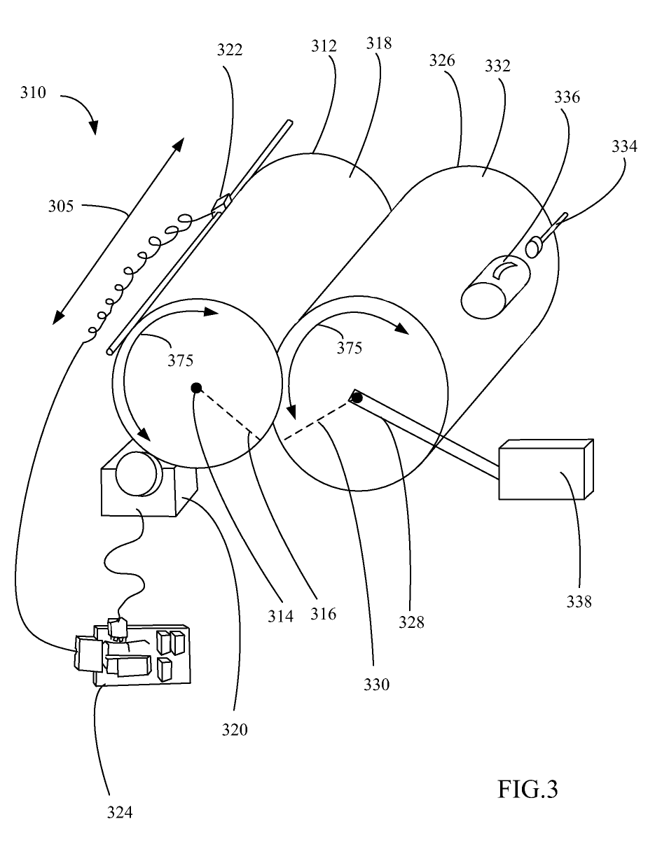

Referring to FIG. 3, another embodiment of an ink jet pad printing system in accordance with the invention is generally shown at 310.

The embodiment shown in FIG. 3 includes a cliché device 312 including axis 314 and a radius 316. Cliche device 312 is rotatable around axis 314. In one embodiment, cliché device 312 is cylindrical. In other embodiments, the cliché device 312 assumes other geometrical formations, such as square, rectangular, octagon, pentagon, and the like. The cliché device 312 includes an imaging surface 318 located on at least part of its circumference. The imaging surface 318 is configured to hold deposited ink. In one embodiment, imaging surface 318 includes at least one etched zone similar to imaging surface as described above with reference to FIG. 1. A cliché device transport mechanism 320 is operably engaged with the cliché device 312. Cliche device transport mechanism 320 is configured to rotate the cliché device 312 about axis 314.

An ink jet printing mechanism 322 is positionable in a direction parallel to axis 314. The ink jet printing mechanism 322 and cliché device transport mechanism 320 are operably attached to an ink jet printing controller 324. In one embodiment, ink jet printing controller 324 is operably connected to a computer (not shown) or to a network (not shown) such as a WAN, LAN, or the Internet.

A pad assembly 326 has an axis 328 and a radius 330, and is rotatable around the axis 328. The pad assembly 326 has a deformable pad 332 located on at least part of its circumference.

A workpiece holder 334 holds a workpiece 336, and is configured to hold the workpiece 336 in compressed contact with the deformable pad 332, and to translate or rotate the workpiece 336 as the pad assembly 326 rotates, during at least part of a printing cycle.

In one embodiment, an engagement device 338 is operably attached to the pad assembly 326. The engagement device 338 is configured to engage and disengage the pad assembly 326 with the cliché device 312 or the workpiece 336 or both during appropriate parts of the printing cycle. In one embodiment, the engagement device 338 is connected to at least one of the ink jet printing controller 324, a general purpose computer (not shown), an ASIC controller (not shown), a WAN(not shown), a LAN(not shown), and the Internet(not shown).

Ink jet printing mechanism 322 translates along first direction 305. Imaging surface 318 and deformable pad 332 rotate in second direction 375. The rotation can include a clockwise, or counterclockwise rotation.

The pad assembly 326 is positioned to hold the deformable pad 332 in compressed contact with imaging surface 318. Rotation of cliché device 312 results in the pad assembly 326 counter-rotating in such manner that the movement of the imaging surface 318 matches the movement of the deformable pad 332 in direction and speed in the region of contact. Such movement is herein described as “a first rotatable element rolling against a second rotatable element.” The deformable pad 332 can be rolled against the cliché device 312 by friction in the region of contact, by the cliché device transport mechanism 320, or by a similar independent mechanism.

The workpiece holder 334 is positioned to hold the workpiece 336 in compressed contact with the deformable pad 332. The workpiece 336 can then be rolled against the deformable pad 332 by friction in the region of contact or by rotation of the workpiece holder 334.

If the workpiece 336 surface is flat, the workpiece holder 334 translates the workpiece 336 in a direction and with a speed matching the direction and speed of the deformable pad 332 in the region of contact. Such movement is herein described as “a rotatable element rolling against a flat element.

In operation, the ink jet printing controller 324 controls the ink flow of the ink jet printing mechanism 322, the position in the first direction 305 of the ink jet printing mechanism 322, and the position in the second direction 375 of the cliché device 312, thereby forming an ink jet deposited image on the imaging surface 318. The cliché device 312 rolls against the pad assembly 326, transferring the ink jet deposited image from the imaging surface 318 to the deformable pad 332. The pad assembly 326 rolls against the workpiece 336, transferring the ink jet deposited image from the deformable pad 332 to the workpiece surface 340.

The engagement device 338 can operate in any of several ways. In one mode of operation, the pad assembly 326 is disengaged from the cliché device 312 and the workpiece 336 while the ink jet printing mechanism 322 forms an ink jet deposited image on the imaging surface 318. Then the pad assembly 326 is engaged with the cliché device 312 to transfer the ink jet deposited image to the pad assembly 326. Based on the transfer, the pad assembly 326 is disengaged from the cliché device 312 and engaged with the workpiece 336 to transfer the ink jet deposited image to the workpiece 336.

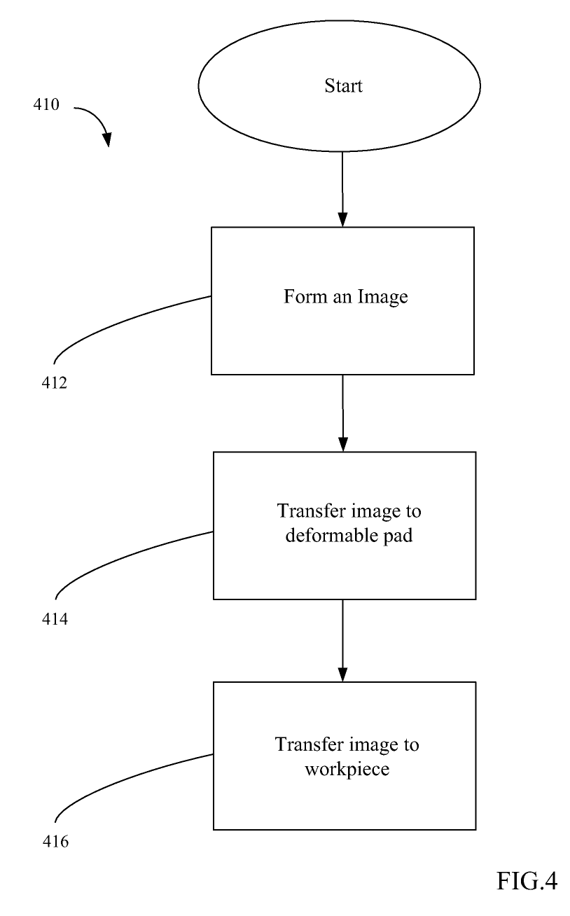

FIG. 4 illustrates a method 410 of printing an ink jet deposited image on a workpiece surface with an ink jet pad printing system in accordance with one aspect of the invention.

In step 412, an ink jet printing mechanism is operated to form an ink jet deposited image on an imaging surface of a cliché device. In one embodiment, step 412 is implemented by moving an ink jet printing mechanism in both a first direction and a second direction, as in FIG. 1, or by moving the ink jet printing mechanism in the first direction and moving the cliché device in the second direction, as in the embodiments shown in FIGS. 2 and 3, or in any other appropriate manner.

In step 414, a deformable pad is pressed against the cliché device, transferring the ink jet deposited image to a surface of the deformable pad. In one embodiment, step 414 is implemented by pressing the cliché device and the deformable pad together in a direction perpendicular to the surfaces of the cliché device and deformable pad if both are flat, as in the embodiments shown in FIG. 1 and FIG. 2, or by rolling the cliché device against the deformable pad if both are curved in the second direction, as in the embodiment shown in FIG. 3, or by any other appropriate manner.

In step 416 the deformable pad is pressed against a workpiece, transferring the ink jet deposited image to the workpiece surface. Step 416 can be performed by pressing the deformable pad and the workpiece together in a direction perpendicular to the surfaces of the deformable pad and the workpiece if both are flat, as in the embodiments shown in FIG. 1 or FIG. 2, or by rolling the deformable pad against the workpiece if the deformable pad is curved in the second direction, as in the embodiment shown in FIG. 3, or by any other appropriate manner.

A cliché device can be configured as a flat plate as in the embodiments shown in FIG. 1 or FIG. 2, as a cylindrical plate as in the embodiment shown in FIG. 3, or in any other shape capable of receiving an ink jet deposited image and transferring the ink jet deposited image to a deformable pad.

A deformable pad can be configured as a substantially flat pad as in the embodiments shown in FIG. 1 and FIG. 2, a cylindrical pad as in the embodiment shown in FIG. 3, or in any other shape capable of transferring an ink jet deposited image from an image surface to a workpiece.

In one embodiment, the ink jet printing mechanism and the ink jet printing controller are configured to deposit at least one stream of ink simultaneously and independently on an imaging surface. An ink jet printing mechanism which is furnished with multiple streams of ink in different colors can be operated to form a multiple-color ink jet deposited image on the imaging surface in a single operation.

In one embodiment, the ink jet mechanism controller is configured to begin depositing ink on the imaging surface as soon as the deformable pad has transferred a previous printing cycle's ink from the imaging surface, and the pad assembly, if any, has been lifted clear. In this manner, an ink jet pad printing system's consecutive printing cycles can be overlapped, increasing the system's speed of operation.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

What is claimed is:

1. A pad printing system comprising:
an ink jet printing mechanism;
a cliché device including at least one imaging surface;
at least one pad assembly including a deformable pad, the pad assembly operably engagable with the cliché device; and
an ink jet printing controller operably attached to the ink jet printing mechanism, wherein the ink jet printing controller controls positioning of the ink jet printing mechanism to deposit a ink jet deposited image on the imaging surface.

2. The pad printing system of claim 1, wherein the imaging surface includes at least one etched zone.

3. The pad printing system of claim 2, wherein the etched zone includes uniform etching that is not indicative of the ink jet deposited image.

4. The pad printing system of claim 1, wherein the imaging surface is substantially flat, and a surface of the deformable pad is substantially flat when the deformable pad is pressed against the imaging surface.

5. The pad printing system of claim 1, wherein the ink jet printing controller is operably attached to the cliché device.

6. The pad printing system of claim 5, wherein:
the cliché device includes a radius;
the imaging surface is on a circumferential surface on the cliché device; and
the deformable pad includes a radius.

7. A system for printing an image on a workpiece surface, the system comprising:
means for operating an ink jet printing mechanism to form an ink jet deposited image on a cliché device by depositing ink in a ink jet deposited image;
means for transferring the ink jet deposited image from the cliché device to a deformable pad; and
means for transferring the ink jet deposited image from the deformable pad to the workpiece surface.

8. A method of printing an image on a workpiece surface, comprising:
forming an ink jet deposited image on an imaging surface of a cliché device;
transferring the ink jet deposited image from the imaging surface to a deformable pad; and
transferring the ink jet deposited image from the deformable pad to the workpiece surface.

9. The method of claim 8, wherein transferring the ink jet deposited image from the imaging surface comprises pressing the deformable pad against the imaging surface.

10. The method of claim 9, wherein transferring the ink jet deposited image from the imaging surface comprises rotating at least one of the cliché device and the deformable pad relative to the other.

11. The method of claim 8, wherein transferring the ink jet deposited image from the deformable pad comprises pressing the deformable pad against the workpiece.

12. The method of claim 11, wherein transferring the ink jet deposited image from the imaging surface comprises rotating at least one of the cliché device and the deformable pad relative to the other.

13. The method of claim 8, wherein the cliché device includes a radius and the imaging surface is on a circumferential surface of the cliché device, the deformable pad includes a radius, and the workpiece surface includes a radius, and wherein transferring the ink jet deposited image from the imaging surface comprises pressing the deformable pad against the imaging surface.

14. The method of claim 13, wherein transferring the ink jet deposited image from the imaging surface comprises rolling the deformable pad against the cliché device.

15. The method of claim 8, wherein transferring the ink jet deposited image from the deformable pad comprises pressing the deformable pad against the workpiece.

16. The method of claim 15, wherein transferring the ink jet deposited image from the deformable pad further comprises rolling the deformable pad against the workpiece.
